(19) United States
(12) Patent Application Publication
(10) Pub. No.: US 2012/0290313 A1
(43) Pub. Date: Nov. 15, 2012

(54) Systems and Methods for Distributed Health Care

(75) Inventor: Patrick W. Blanshard, London (CA)

(73) Assignee: SENSORY TECHNOLOGIES OF CANADA, INC., London (CA)

(21) Appl. No.: 13/467,951

(22) Filed: May 9, 2012

Related U.S. Application Data
(60) Provisional application No. 61/484,644, filed on May 10, 2011.

(30) Foreign Application Priority Data
May 10, 2011 (CA) 2739308

(51) Int. Cl. G06Q 50/22

(52) U.S. Cl. 705/2

(57) ABSTRACT

Distributed health care uses personal support workers (PSW) and registered, trained medical personnel. Each PSW is equipped with a mobile computing device that is capable of communicating with a main computer. Each registered medical personnel is equipped with a computing device (a monitoring computer) that is capable of communicating with a main computer. At times during a PSW's shift at a patient location, the PSW inputs data to a number of forms on the mobile computing device, each form being related to the patient's physical appearance, medical condition, medication taken or given, and physical parameters, or other actions taken. The data inputted are then transmitted to the main computer, which processes, stores, and archives the data. After processing, the data is reviewed by the registered medical personnel. If the data indicates that actions need to be taken, the medical personnel can issue instructions to the PSW.

### CROSS REFERENCE TO RELATED APPLICATIONS

This application claims priority under 35 U.S.C. §119(a) to Canadian Application No. 2,739,308, filed on May 10, 2011. This application claims priority under 35 U.S.C. §119(e) to U.S. Application No. 61,484,644, filed on May 10, 2011. Both of these applications are incorporated herein by reference in their entirety.

### TECHNICAL FIELD

The description relates to medical monitoring technologies. More specifically, the description relates to methods and systems for use in a distributed medical care system that takes advantage of multiple personal support workers providing care to patients which are remotely managed by at least one registered medical professional.

### BACKGROUND

The medical field is currently suffering from a shortage of fully trained medical personnel. The issue is that registered nurses (RNs) do not have the sufficient numbers to attend to those who are on an outpatient basis nor those who require regular homecare visits. There are an insufficient number of nurses to care for patients who are in their home but would normally be in the hospital. These patients, who may require palliative care, complex care, paediatric care, or a similar level of attention, may normally be in a hospital. Such patients, located in their homes, normally require at least one shift of nurse care, that is, a nurse would be at their location for up to 12 hours a day.

### SUMMARY

While there are personal support workers (PSWs) or nurse's aides (also termed as unlicensed assistive personnel) who perform some of the required duties in these homecare scenarios, these PSWs are, unfortunately, not trained, certified medical personnel. As well, they do not have the experience to recognize potential danger signs nor potential emergency situations developing from the patient's current condition. Trained and experienced certified medical personnel (for example, a registered nurse with years of experience) can recognize potential problems with a patient given the patient's physical parameters such as blood pressure, temperature, appearance, etc. However, as noted above, these valuable medical personnel have inadequate numbers to address the growing number of patients who are on an outpatient, homecare, or remote care basis.

One option to address the above would be to increase the number of registered nurses (who are always in great demand worldwide). This approach, unfortunately, takes too much time as increasing the number of registered nurses is a measure that usually takes up to a decade; nurses have to be put through school, certified, and trained. As well, once a nurse is trained, there is no guarantee that the nurse will stay in the city, province, state, or even country where he or she trained.

The description relates to systems and methods for distributed health care using personal support workers (PSWs) and registered, trained medical personnel. Each PSW is equipped with a mobile computing device that is capable of communicating with a main computer. Each registered medical personnel is equipped with a computing device (a monitoring computer) that is capable of communicating with a main computer. At many points during a PSW's shift at a patient location, the PSW inputs data to a number of forms on the mobile computing device, each form being related to the patient's physical appearance, medical condition, medication taken or given, and physical parameters (for example, blood pressure), or other actions taken. The data inputted into the various forms are then transmitted to the main computer where it is processed, stored, and archived. When processing the data, the main computer may determine to alert the registered medical personnel and/or suggest a course of action. After processing, the data is reviewed by the registered medical personnel. If the data indicates that actions need to be taken, the medical personnel can issue instructions to the PSW through the system.

In a first aspect, a system monitors and manages a plurality of patients. The system includes a main computer coupled to at least one network and capable of communicating with other computing devices; a plurality of computing devices, each of the plurality of computing devices being operated by a registered medical professional physically remote from a location of the main computer; a plurality of mobile computing devices, each of the plurality of mobile computing devices being operated by a caregiver at a patient location physically remote from a location of the monitoring computer. The main computer receives communications from the plurality of mobile computing devices, the communications including at least one of: reports on physical parameters for at least one patient at the patient location; reports on symptoms of the at least one patient at the patent location; and reports on medication administered by the caregiver to at least one patient at the patient location. Each of the mobile computing devices provides the caregiver with an interface for two-way communication between the registered medical professional and the caregiver by way of the main computer and the caregiver provides the reports by way of forms relating to physical parameters for at least one patient at the patient location.

In another general aspect, a method is performed for managing a plurality of patients. The method includes receiving, at a main computer, data relating to health parameters of a patient, the data being sent to the main computer by a mobile computing device, the mobile computing device being operated by a caregiver at a patient location remote from the main computer; and, in the event the health parameters are not within acceptable limits, initiating a two-way communications link between a monitoring computer and the mobile computing device, the monitoring computer being operated by a registered medical professional.

In another general aspect, a method is performed for monitoring a patient's condition. The method includes presenting a plurality of forms to a caregiver by way of a mobile computing device, each one of the plurality of forms being related to the patient's physical condition and appearance; receiving input from the caregiver by way of the plurality of forms; transmitting data from the plurality of forms from the mobile computing device to a main computer by way of a data communications network; and, in the event the data indicates a condition, for the patient, that is outside normal parameters, receiving instructions from a monitoring computer.

### DESCRIPTION OF THE DRAWINGS

FIG. 1 is a block diagram of an exemplary health care system;

FIG. 1A is a block diagram of an alternative health care system to that illustrated in FIG. 1;

FIG. 2 is a screenshot of a user interface for the monitoring computer illustrated in FIG. 1;

FIG. 3 is a screenshot of a user interface for recording a patient's blood pressure on a mobile computing device illustrated in FIG. 1;

FIG. 4 is a screenshot of a user interface for recording a patient's temperature on a mobile computing device illustrated in FIG. 1;

FIG. 5 is a screenshot of a user interface for recording a patient's eye reactions on a mobile computing device illustrated in FIG. 1;

FIG. 6 is a screenshot of a top-level main menu user interface for a mobile computing device illustrated in FIG. 1;

FIG. 7 is a screenshot of a user interface for recording a PSW's initial assessment of a patient's condition on a mobile computing device illustrated in FIG. 1;

FIG. 8 is a screenshot of a user interface menu for the PSW category on a mobile computing device illustrated in FIG. 1;

FIG. 9 is a screenshot of a user interface menu for the Intervention category on a mobile computing device illustrated in FIG. 1;

FIG. 10 is a screenshot of a user interface for the Critical Event category on a mobile computing device illustrated in FIG. 1;

FIG. 11 is a screenshot of a user interface menu for the monitoring computer illustrated in FIG. 1 and shows a two-way chat or text communication between a PSW and a registered medical professional;

FIG. 12 is a flowchart of a exemplary procedure performed by the monitoring computer; and

FIG. 13 is a flowchart of an exemplary procedure performed by a mobile computing device.

### DETAILED DESCRIPTION

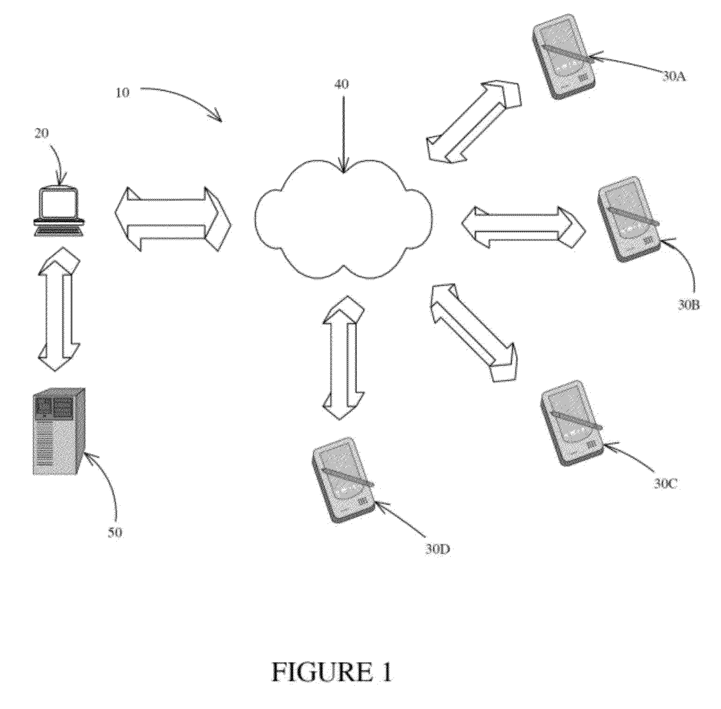

Referring to FIG. 1, a block diagram of a health care system 10 is illustrated. As can be seen, the system 10 includes a monitoring computer 20, and a plurality of mobile computing devices 30A, 30B, 30C, 30D. A network 40 is used for communications between the mobile computing devices 30A-30D and the monitoring computer 20. A database main computer 50 is coupled to the monitoring computer 20 to store data received from the various mobile computing devices.

Another exemplary health care system 10A is illustrated in FIG. 1A. In FIG. 1A, monitoring computer 20 communicates with mobile computing devices 35A and 35B using network 40 and main computer 60. Also, monitoring computer 25 communicates with mobile computing devices 35C and 35D by way of network 40A and main computer 60. As can be seen, communications between the mobile computing devices and the monitoring computers pass through the main computer 60. This enables the main computer 60 to process, archive, and store these communications between the mobile computing devices and the monitoring computers. Communications between the main computer 60 and any of the monitoring computers 20, 25 may also pass through a suitable data communications network. Networks 40 and 40A may be of the same type of data communications network or they may be dissimilar types of communications networks.

The system operates with each monitoring computer 20, 25 being operated by a trained, registered medical professional such as, preferably, an experienced registered nurse. The mobile computing devices are operated and used by personal support workers (PSWs), also known as nurse's aides. Personal support workers are trained but non-regulated personnel trained to operate the mobile computing devices, care for patients, take health readings (such as, for example, blood pressure, pulse, and temperature readings), provide first aid, administer at least some medication, and operate as the eyes, ears, and, where necessary, hands of the registered medical professional. Each registered medical professional operating a monitoring computer monitors and manages multiple PSWs and the patients cared for by those PSWs.

As can be seen from FIG. 1, the registered medical professional who operates the monitoring computer 20 monitors and manages the PSWs who are using mobile computing devices 30A-30D. From FIG. 1A, the registered medical professional who operates monitoring computer 20 monitors and manages the PSWs who are using mobile computing devices 35A, 35B while the registered medical professional who is operating monitoring computer 25 monitors and manages the PSWs operating the mobile computing devices 35C and 35D. In this configuration, the main computer 60 receives all the communications from the various mobile computing devices, processes these communications as well as the data contained in them (including archiving the data), and routes them to the proper monitoring computer. The main computer 60 may, depending on its configuration, also reassign which mobile computing device is managed by which monitoring computer.

Regarding the components illustrated in FIGS. 1 and 1A, the networks 40 and 40A may include the Internet, a dedicated local area network (LAN), a virtual private network (VPN), or any other data network that may be used to communicate and transfer data between two data processing devices. Each monitoring computer can be a dedicated personal computer (including a laptop) with suitable hardware for communicating with the network or with a suitable main computer. Alternatively, as shown in FIG. 1A, the monitoring computer can be one of a number of monitoring computers networked together with a suitable main computer to provide access to the various mobile computing devices in the system. The mobile computing devices can be any suitable computing device that allows users to access the network, display and receive input into preset forms and which will allow communications with the monitoring computer, either directly or through a suitable main computer. Smart phones, tablet computers, laptops, and any other such device can be used as one of the mobile computing devices.

Each PSW attends to a patient for a specific shift (which may be as long as 12 hours) during which the PSW provides care to the patient under the management and supervision of the registered medical professional. During that shift, the PSW fills out the necessary forms on the mobile computing device for the specific patient. These forms have entries for the various physical parameters of each patient and their surroundings such as their blood pressure, appearance, any symptoms they may have, medication (for example, whether any medication has been prescribed, whether they are taking their medication, etc.), the state of any medical equipment they are using (for example, if they are on a heart monitor, is the heart monitor in good, working condition), the patient's mood, etc. Once these forms are completed by the PSW, the data is then transmitted to the monitoring computer (perhaps by way of the main computer) where they are displayed for review by the medical professional. If the medical professional sees anything amiss or anything that raises a concern, the medical professional can initiate a two way communication with the PSW at the scene. Similarly, if the PSW sees anything that is of concern, the PSW can initiate a two way communication with the medical professional through the monitoring computer.

The two-way communication referred to above may take various forms. An instruction and response type of communication (that is, a workflow based type) may be implemented where the registered medical professional sends instructions to the PSW of what to do. For each instruction, the PSW then responds with confirmation that the instruction has been executed or that the instruction has not been executed along with reasons why the instruction was not implemented. The PSW can also respond with a request for further clarification regarding the instruction. It should be noted that this workflow-based communication is tracked on both a registered medical professional's “dashboard” on the monitoring computer and on the mobile computing device. Each instruction is noted on the monitoring computer and on the mobile computing device. Each instruction can only be marked or treated as being done/executed by the registered medical professional once he or she is satisfied with the response from the PSW. As will be described below in greater detail, the PSW has a number of options for responding to each instruction. Once an instruction has been marked as being executed by the registered medical professional, the instruction is similarly marked on the PSW's mobile computing device. All of the instructions and the PSW's responses to the instructions are stored in the database and are associated with the particular patient to whom it applies.

Another form of a two-way communication may be through well-known encrypted chat/text communications protocols where a free-flowing conversation between the registered medical personnel and the PSW can develop. This communications channel allows for low patient impact and silent conversations between the PSW and the registered medical professional. These chat/text communications are logged in the database but may not necessarily be associated with a specific patient.

It should also be noted that each PSW may visit one patient each day at a patient location for a specific shift. The patient location may be the patient's home, an outpatient facility, a nursing home, and other non-hospital or non-clinical facilities. The concept is that the patient, by having a PSW available during the shift, receives quasi-hospital level long term care without taking up hospital space. At times other than the PSW's shift, the patient would be cared for by his or her relatives or some other caregiver. Of course, it may be possible that the patient would receive 24-hour PSW care with different PSWs taking different shifts during the day. In one implementation, each PSW is tasked with shifts for specific patients in their homes (especially complex-care and palliative care patients). Each monitoring computer operated by a registered medical professional is associated with a set group of PSWs with mobile computing devices and each group of PSWs is tasked with the care of a set group of patients.

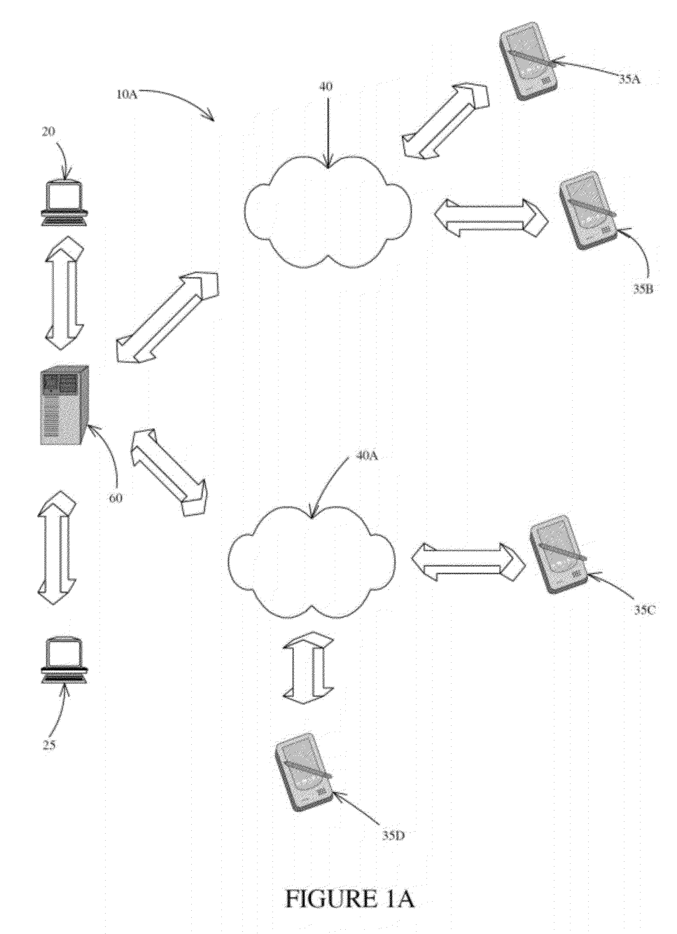

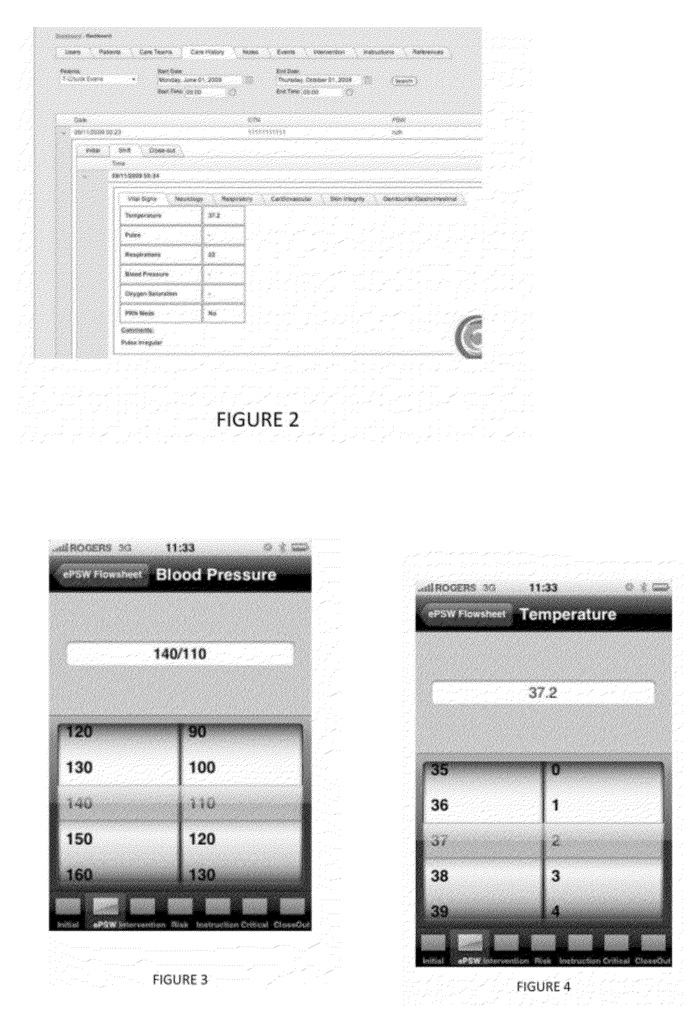

Referring to FIG. 2, an example of a screen or “dashboard” of the monitoring computer for a registered medical professional is illustrated. Each PSW works a shift and at the beginning of each shift, the PSW takes readings of the patient's physical parameters (for example, the patient's vital signs). These readings are then transmitted to the monitoring computer where the readings are provided to the registered medical professional. As can be seen from FIG. 2, the vital signs are shown to the medical professional. The other readings are also to be presented to the medical professional. From FIG. 2, it can be seen that multiple categories of readings for the patient are also taken. Readings related to the patient's vital signs, neurology, respiratory system, cardiovascular system, skin integrity, and gastrointestinal system are taken by the PSW and the readings are sent to the monitoring computer. These readings are then reviewed by the registered medical professional to ensure that they are within acceptable parameters. As can also be seen, the “dashboard” for the monitoring computer displays not only the readings for the patient but also identifies the patient, the PSW attending to the patient, and the registered medical professional monitoring the readings.

Also part of the dashboard for the registered medical professional is a window (not shown) that provides the user with a history of a particular patient's medical history and a history of the various readings taken of that patient's vital signs. This history of the patient's vital signs (from previous readings taken by PSWs) can allow the registered medical professional to quickly determine, at a glance, whether the current readings are within acceptable parameters or not. By quickly comparing the current readings taken by the PSW with the historical data, the registered medical professional can determine whether further confirmatory readings are required or whether a dangerous condition is occurring. It should be noted that if the registered medical professional determines that at least one reading is not within acceptable parameters, s/he may direct the PSW to take more readings to determine if the previous readings were accurate.

Again regarding the dashboard, the current readings or data entries for each patient can be provided side by side with the historical data for that same patient. A side-by-side comparison allows the registered medical professional to quickly determine if the new data is within acceptable parameters of the historical data. Moreover, any outstanding instructions to the PSW can be shown on the dashboard adjacent to the current readings.

Referring to FIG. 3, an example of a form on a mobile computing device, to be completed by a PSW, is presented. As can be seen, the form is related to a patient's blood pressure reading. The mobile computing device interface is that used on the Apple iPhone™ which implements a swipe-capable touch screen. A PSW thus only has to select the correct reading to complete the form. Of course, other user interfaces, such as those that require the PSW to enter numbers on the mobile computing device, may also be used.

Again referring to FIG. 3, the bottom of FIG. 3 illustrates the various categories of menus and forms available to the PSW. These categories are listed below.

INITIAL ASSESSMENT: An “initial assessment” menu (shown as “initial” in the Figure) relates to forms and menus used by the PSW when the PSW initially takes responsibility for the patient at the beginning of a shift. The patient's physical condition as well as the patient's physical readings are entered at the beginning of the shift.

ePSW: The “ePSW” menu relates to the forms related to the main physical parameters for the patient that the PSW has to measure and/or determine (including blood pressure, temperature, etc.). The highlighted box for the “ePSW” category indicates that the form currently being presented to the PSW is related to the ePSW menu. It should be noted that the patient's condition may be documented multiple times during a PSW's shift. Each time the patient's condition is documented (including all physical parameter readings), these are entered by way of the menus and forms in the ePSW category.

INTERVENTION: The “Intervention” category relates to forms and interfaces for events in which the registered medical professional has to intervene in the PSW's duties. These forms and interfaces are accessed when the PSW is required to respond to a significant, but non-life threatening, change in a patient's status.

It should be noted that the menus and forms in the Intervention category combines forms that relate to the patient's vital signs as well as more detailed forms and questions that requires the PSW to collect precise information regarding which of the patient's physical systems are affected as well as the actions taken by the PSW and the registered medical professional to address the event. Of course, the data collected by the PSW for this category is communicated to the monitoring computer so that it can be reviewed by the registered medical professional. This data can be transmitted to the monitoring computer by way of the main computer with the main computer processing, storing, and associating the data with the relevant patient.

It should also be noted that when a patient requires clinical intervention within the scope of practice as defined appropriate for a PSW with enhanced training, the PSW performs the necessary intervention where appropriate or waits for registered medical professional's direction. Regardless of what occurs, the PSW documents the current situation using the menus and forms in the intervention category.

RISK: The “Risk” category relates to forms and interfaces to be used to document a non-patient system specific issue and to alert the registered medical professional of the issue. These events may be further subcategorized into Psychosocial, Technical, Environmental, and Health & Safety issues. Events such as the breakdown of medical equipment at the site (a technical issue) or power being cut (an environmental issue) can therefore be catalogued in the patient's file. By documenting such issues, and by having the issue automatically communicated to the monitoring computer, the registered medical professional is made aware of the issue and, if necessary, can take steps to address the situation.

INSTRUCTION: The “Instruction” category relates to forms and interfaces to be used when the registered medical professional has to provide instructions to the PSW. Events such as when the PSW has to administer a medication (perhaps through a syringe) may require instructions from the medical professional. An “Instruction” event may also arise when the registered medical professional, after reviewing the most recent readings (for example, the patient's vital signs) taken by the PSW, becomes concerned. The registered medical professional may then complete a concise instruction form on the dashboard for the PSW. The PSW then has a limited number of options: complete the instruction (that is, execute the instructions received) and confirm that the instructions have been carried out, request clarification (preferably through a single message), or reject the instruction with a single message. If the two latter options are exercised, the PSW has to contact the registered medical professional, preferably through a telephone call. It should be noted that the request for clarification is preferably limited to a single message to avoid a lengthy back and forth between the PSW and the registered medical professional.

CRITICAL: The “Critical” category relates to forms and menus for use when a “critical event” occurs. A “Critical Event” is defined as a medical emergency that is outside of the scope of practice for the PSW. If a critical event occurs while the PSW is on-site, the PSW performs two roles, that of first-aider and that of documentarian. As an example, if the patient's condition quickly deteriorates and an ambulance is required, the PSW calls for the ambulance and, once the patient has been taken away, the PSW fills out the forms and describe the events leading up to and after the critical event. After the event has stabilized, and it is appropriate to do so, the PSW documents the occurrence in the flow sheet sending the information to the registered medical professional for his/her additions and commentary.

CHECK-OUT: The “check-out” category relates to forms and interfaces that the PSW uses when he or she is about to finish the shift. These forms and interfaces are used to document the patient's condition and physical parameters prior to passing on the responsibility for the patient to another caregiver. These forms and interfaces allow for a detailed comparison of the condition of the patient when the PSW took responsibility for the patient at the beginning of the shift.

Referring to FIG. 4, another form used by the PSW is illustrated. In FIG. 4, the temperature of the patient is recorded. As can be seen, this form is in the ePSW category. However, a corresponding form may also be used in the other categories. For this form, the temperature is entered in two parts—the first part gives the whole number value of the temperature while in the second part gives the first decimal place value of the temperature.

Referring to FIG. 5, a form used to document a patient's neurological responses is illustrated. The form takes into account the patient's left and right pupil reactions to light. As well, the quality of any reaction is documented in the form.

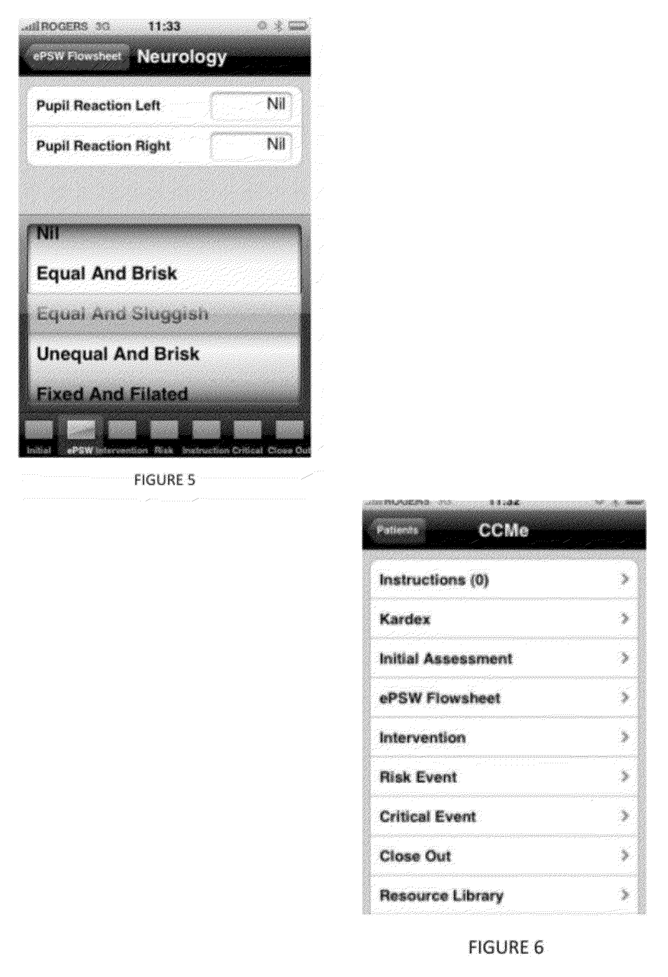

FIG. 6 illustrates the initial menu for the PSW on the mobile computing device. The initial menu shows how many instructions from the registered medical professional still need to be executed (in this case there are no outstanding instructions). The various categories of menus and forms are presented along with two extra categories: the patient history category (labelled as “Kardex” in the Figure) and the “Resource Library”.

The patient history category has forms and menus that give an overview of each patient's condition, diseases, and care plan. The category provides key information that may be of use to the PSW and to the registered medical professional. The data in this category may be retrieved from a central database in real time or, alternatively, may be downloaded by the mobile computing device prior to the PSW's visit to the patient.

The “Resource Library” category provides menus and forms which can be used by the PSW to seek more information on medical topics that he or she may encounter while providing care to a patient. A dedicated medical information database may be resident on the mobile computing device or may be accessible through the mobile computing device. This medical database can be searched by the PSW for definitions of medical terms, procedures, and any other medical information that may be of use to the PSW. As an example, if the registered medical professional gives the PSW an instruction and the PSW is unclear as to one of the terms in the instruction, the definition of that term may be referenced by the PSW through the menus and forms in the Resource Library.

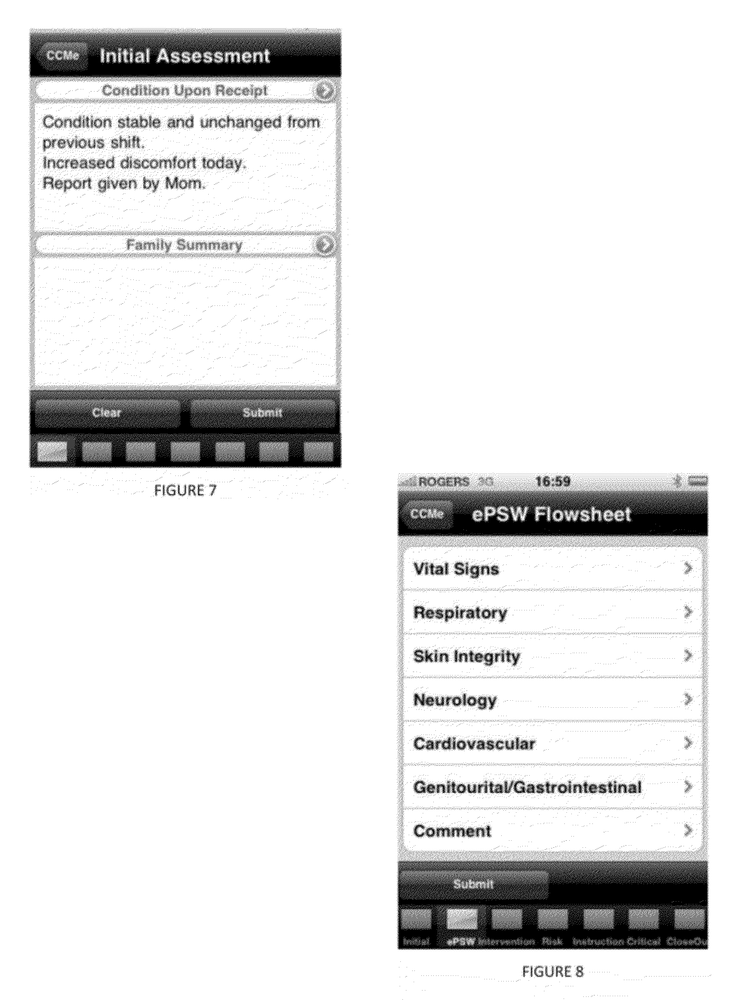

Referring to FIG. 7, one form for the Initial Assessment category is illustrated. The PSW is provided with a free form box into which the PSW may enter his or her assessment regarding the patient and any issues that might be of interest as the shift begins. For complex care patients or patients who are being taken care of by their family, a Family Summary box is also provided. In this box, the PSW may enter his or her impressions of issues that may be of concern regarding the family providing the care to the patient. The entries made into this form are uploaded to the main computer for review by the registered medical professional on the monitoring computer and for eventual archiving as part of the patient's file.

Referring to FIG. 8, the main menu for the ePSW category is illustrated. As can be seen, presented are the various subcategories of physical parameters, readings, and appearance relating to the patient that the PSW has to take or observe. These subcategories are those of:
Vital Signs
Respiratory
Skin Integrity
Neurology
Cardiovascular
Genitourital/Gastrointestinal

Each subcategory, when accessed, opens up a different form or submenu. Each form to be filled out by the PSW relates to the patient's condition and/or appearance and/or reaction for the physical system of the subcategory. As an example, the Vital Signs subcategory will include forms for the patient's blood pressure, temperature, heart rate, etc.

A final subcategory in FIG. 8 relates to comments that the PSW may wish to make regarding the patient. This subcategory allows the PSW to enter any observations or comments that are not addressed by the other subcategories. As noted above, all of the data entries made in the various subcategories are uploaded to the main computer for review by the registered medical professional on the monitoring computer and for eventual archiving as part of the patient's file.

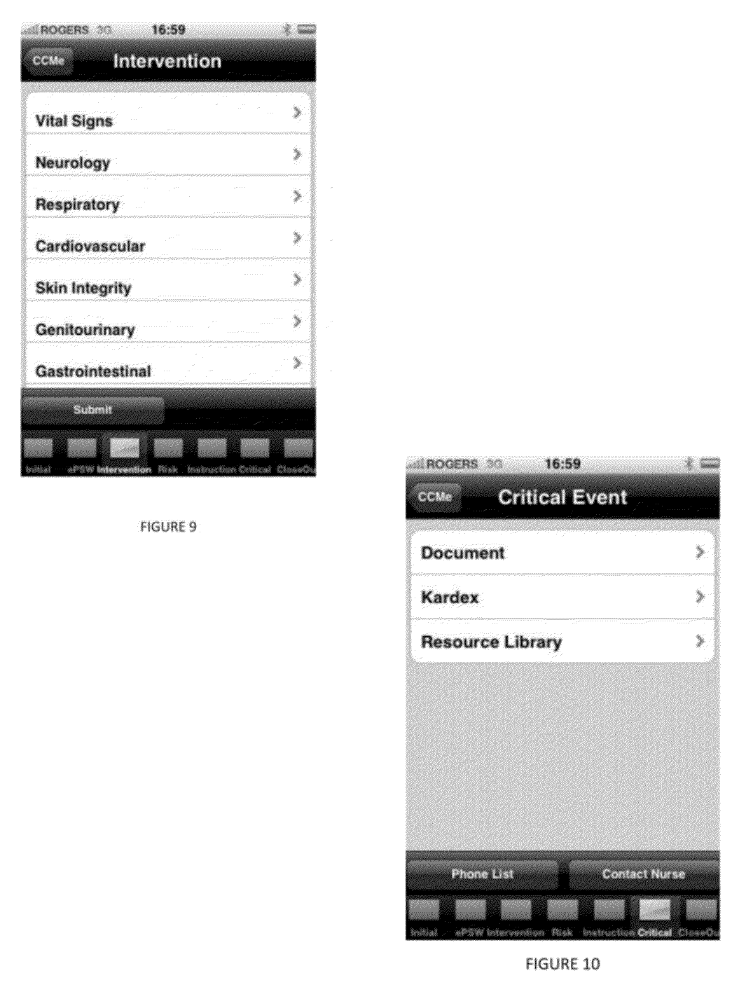

Referring to FIG. 9, the main menu for the category Intervention is illustrated. The subcategories in this menu are similar to those in the ePSW category with the exception that a Comments subcategory is not present. The forms and menus in the various subcategories are those that will be used by the PSW when an intervention by the registered medical professional relates to the relevant subcategory. As an example, if the patient's body temperature is considered high, the intervention by the registered medical professional would be entered using the menus and forms in the Vital Signs subcategory.

The main menu for the Critical Event category has a limited number of entries in FIG. 10. The Document subcategory has menus and forms which allow for the PSW to provide a free-flowing description or narrative of the critical event. The patient history subcategory (labelled as “Kardex” in the Figure) gives the PSW a quick means to determine the patient's medical history while the Resource Library gives the PSW the means to clarify terms and conditions that may be beyond the PSW's experience. The patient history subcategory and the Resource Library also give the PSW the means to provide a context to the critical event as well as the means to couch the event description using the proper medical terms. It should be noted that at the bottom of the menu are two buttons that may be of assistance to the PSW if a critical event occurs—a listing of important telephone numbers and a means to immediately contact the registered medical professional. The Phone List may give the telephone numbers of the nearest hospital, the primary caregiver for the patient (e.g. a relative living with the patient), the patient's next of kin, as well as any other relevant emergency numbers. The Contact Nurse button gives the PSW an immediate means to contact the registered medical professional operating the monitoring computer either by an alert on the monitoring computer or by a telephone call to the facility housing the monitoring computer.

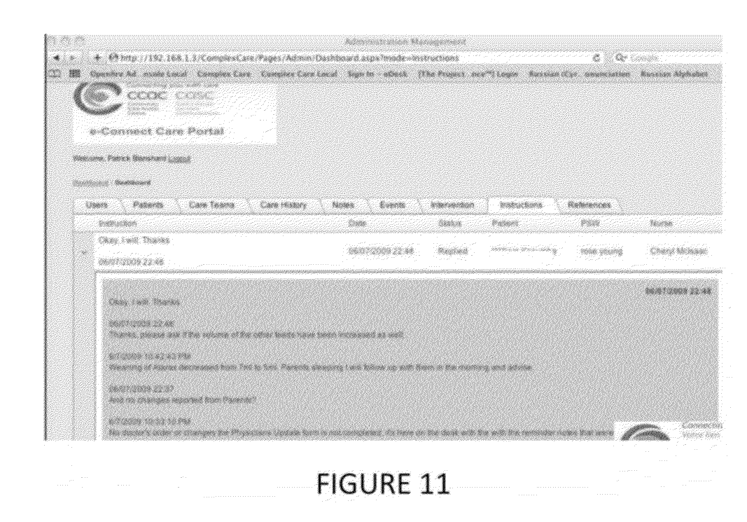

Referring to FIG. 11, another view of the dashboard on the monitoring computer is illustrated. This view shows a chat or text conversation that can occur between the PSW and the registered medical professional monitoring the monitoring computer. As can be seen, this two-way communications link between the PSW and the registered medical professional provides a real-time, time stamped means to discuss critical events, instructions, or anything important that may arise during the PSW's shift.

From the above, it should be clear that the dashboard also provides the registered medical professional with an “instruction portal” or a quick, easily accessible, and ready means to send an instruction to a PSW. This can take the form of, for each PSW on duty and being managed by the registered medical professional, an always accessible window on the monitoring computer. Instructions sent to the PSW can only be registered as being “accomplished” on the monitoring computer by the registered medical professional once he or she has received confirmation from the PSW that the instruction has been executed. As noted above, an instruction is essentially a demand, tied to the patient file, and assigned to the relevant PSW for action. The PSW has three options: to accept, document and then close out, send a request for clarification, or reject with documentation. A fourth option also exists, that of using a telephone call between the PSW and the registered medical professional for clarification. For this fourth option, the documentation regarding the instruction is entered once the call has been completed.

The “dashboard” illustrated in the Figures and the application supporting the dashboard and its functions may be implemented as a software application running on the monitoring computer. Alternatively, the software application can be implemented as a Web-based service. The Web-based service allows the registered medical professional to perform his or her duties from any web-enabled and web-capable monitoring computer.

While the above examples document the menus relating to the PSW and the registered medical professional, the health care system can also be used by visiting clinicians and/or visiting registered medical professionals. The visiting registered medical professionals can visit the patient at the patient location on an as-needed or an as-scheduled basis. Since there are tasks and procedures that can only be executed by registered medical professionals, a visit from such personnel may be warranted for each patient. During such a visit, the registered medical professional can, using his or her own mobile computing device, which is also connected to the monitoring computer, document the procedures implemented as well as any observations and comments he or she may have. This data from the visiting registered medical professional can then be stored in the database against that particular patient's file. The registered medical professional can enter data detailing a change in medication, the administration of medication, instructions to the PSW, etc.

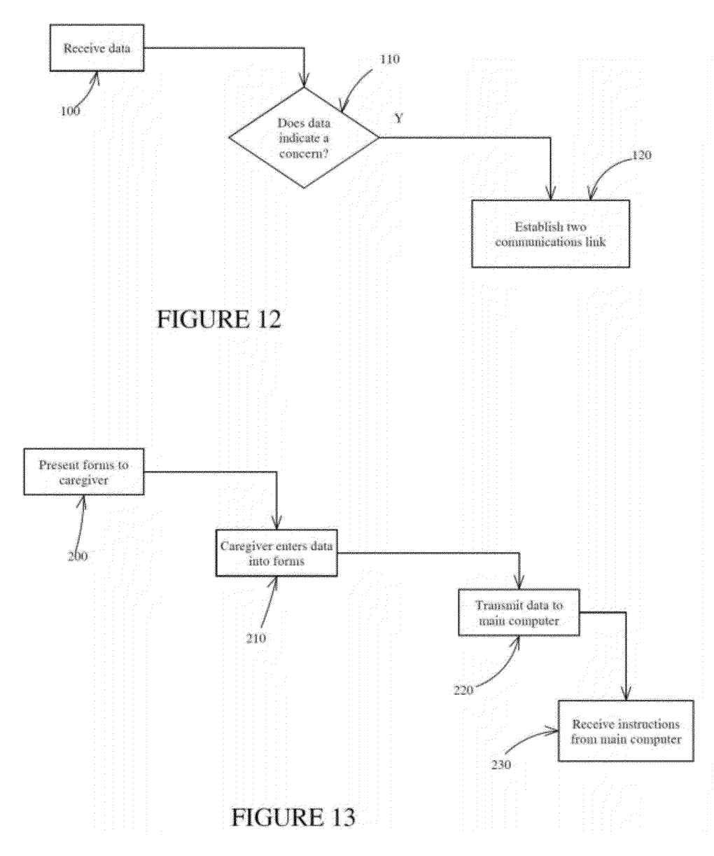

Referring to FIG. 12, a procedure begins at step 100, that of receiving data regarding the condition, appearance, and physical parameters of the patient. The data is transmitted by the mobile computing device to the main computer and then to the monitoring computer for review by the registered medical professional. The data can be related to any of the categories listed above. For example, in some cases, the data is related to the ePSW category. The mobile computing device is operated by a PSW at a patient location physically remote from the monitoring computer. Once the registered medical professional has reviewed the data, if the readings indicate a concern (step 110) then a two-way communications link is initiated between the monitoring computer and the mobile computing device (step 120). The two-way communications link, perhaps a chat or a text conversation or an instruction from the registered medical professional, allows for the PSW and the registered medical professional to determine if the anomalous readings are of concern. The data can also be related to symptoms felt by the patient, the patient's medication, the patient's reaction to medication, or any other event, reading, or data point that may be relevant to the patient's physical, medical, or mental condition.

Referring to FIG. 13 a procedure begins at step 200 with the presentation of forms to a caregiver or PSW using the mobile computing device. The caregiver/PSW then enters data into the forms (step 210). Of course, the forms and the data entered by way of the forms relate to the physical parameters, condition, and/or appearance of the patient. Once the form (or forms) are completed, the data on the forms are transmitted to the main computer (step 220) using a data communications network. If, after a review by the registered medical professional on the monitoring computer, the data indicates conditions that are outside the normal parameters for the patient, the mobile computing device then receives instructions from the monitoring computer (step 230). The instructions can be from the registered medical professional for the PSW to execute or they can be in the form of a chat or text conversation. As noted above, the PSW can then respond to the instruction accordingly.

The steps of the procedures described in FIGS. 12 and 13 can be embodied in sets of executable machine code stored in a variety of formats such as object code or source code. Such code is described generically herein as programming code, or a computer program for simplification. Clearly, the executable machine code can be integrated with the code of other programs, implemented as subroutines, by external program calls or by other techniques as known in the art.

The steps can be executed by a computer processor or similar device programmed in the manner of method steps, or can be executed by an electronic system that is provided with means for executing these steps. Similarly, an electronic memory means such computer diskettes, CD-Roms, Random Access Memory (RAM), Read Only Memory (ROM) or similar computer software storage media known in the art, can be programmed to execute such method steps. As well, electronic signals representing these method steps can also be transmitted via a communication network.

Embodiments of the health care system and the procedure can be implemented in any conventional computer programming language, such as, for example, in a procedural programming language (for example, “C”) or an object oriented language (for example, “C++”, “java”, or “C#”). Alternatively, embodiments of the health care system and the procedure can be implemented as pre-programmed hardware elements, other related components, or as a combination of hardware and software components.

Embodiments can be implemented as a computer program product for use with a computer system. Such implementations can include a series of computer instructions fixed either on a tangible medium, such as a computer readable medium (for example, a diskette, CD-ROM, ROM, or fixed disk) or transmittable to a computer system, via a modem or other interface device, such as a communications adapter connected to a network over a medium. The medium can be either a tangible medium (for example, optical or electrical communications lines) or a medium implemented with wireless techniques (for example, microwave, infrared or other transmission techniques). The series of computer instructions embodies all or part of the functionality previously described herein. The computer instructions can be written in a number of programming languages for use with many computer architectures or operating systems. Furthermore, such instructions can be stored in any memory device, such as semiconductor, magnetic, optical or other memory devices, and may be transmitted using any communications technology, such as optical, infrared, microwave, or other transmission technologies. Such a computer program product can be distributed as a removable medium with accompanying printed or electronic documentation (for example, shrink wrapped software), preloaded with a computer system (for example, on system ROM or fixed disk), or distributed from a main computer over the network (for example, the Internet or World Wide Web). Of course, some embodiments can be implemented as a combination of both software (for example, a computer program product) and hardware. Still other embodiments can be implemented as entirely hardware, or entirely software (for example, a computer program product).

Other implementations are within the scope of the following claims.

What is claimed is:

1. A system for monitoring and managing a plurality of patients, the system comprising:
a main computer coupled to at least one network and capable of communicating with other computing devices;
a plurality of monitoring computing devices, each of the plurality of monitoring computing devices being operated by a registered medical professional physically remote from a location of the main computer; and
a plurality of mobile computing devices, each of the plurality of mobile computing devices being operated by a caregiver at a patient location physically remote from a location of the monitoring computer;
wherein:
the main computer receives communications from the plurality of mobile computing devices, the communications comprising at least one of:
reports on physical parameters for at least one patient at the patient location;
reports on symptoms of the at least one patient at the patent location; and
reports on medication administered by the caregiver to at least one patient at the patient location; and
each of the mobile computing devices provides the caregiver with an interface for two-way communication between the registered medical professional and the caregiver by way of the main computer and the caregiver provides the reports by way of forms relating to physical parameters for at least one patient at the patient location.

2. The system of claim 1, wherein at least one patient location is a home of a patient.

3. The system of claim 1, further comprising a storage subsystem for storing reports and forms received by the monitoring computer.

4. The system of claim 1, wherein each of the mobile computing devices also provides the caregiver with at least one of:
forms regarding symptoms of the at least one patient at the patent location; and
forms regarding medication administered by the caregiver to at least one patient at the patient location.

5. The system of claim 1, wherein the forms relate to a critical event relating to the patient.

6. The system of claim 1, wherein the interface for two-way communications comprises an instruction and response interface for the registered medical professional to send instructions to the caregiver and for the caregiver to respond to the instructions.

7. The system of claim 6, wherein the instructions are tracked on both the monitoring computer and the mobile computing device.

8. The system of claim 7, wherein only the registered medical professional is able to mark an instruction as being executed.

9. The system of claim 1, wherein each monitoring computer is coupled to the main computer for archiving data received from the mobile computing devices.

10. The system of claim 1, wherein the monitoring computer and the mobile computing devices communicate with one another through the main computer, the main computer being for processing data received from the monitoring computer and the mobile computing devices.

11. The system of claim 10, wherein a plurality of other monitoring computers are coupled to the main computer, each of the other monitoring computers managing a plurality of mobile computing devices.

12. A method for managing a plurality of patients, the method comprising:
receiving, at a main computer, data relating to health parameters of a patient, the received data being sent to the main computer by a mobile computing device, the mobile computing device being operated by a caregiver at a patient location remote from the main computer; and
in the event the health parameters are not within acceptable limits, initiating a two-way communications link between a monitoring computer and the mobile computing device, the monitoring computer being operated by a registered medical professional.

13. The method of claim 12, wherein the data comprises symptoms observed by the caregiver on the patient.

14. The method of claim 12, wherein the data comprises medication administered by the caregiver to the patient.

15. The method of claim 14, wherein the data further comprises reactions by the patient to the medication.

16. The method of claim 12, wherein the data is entered by the caregiver into the mobile computing device by way of predetermined forms presented on the mobile computing device.

17. The method of claim 12, wherein the data is stored in a storage subsystem.

18. The method of claim 12, wherein the data relates to a critical event relating to the patient.

19. A method for monitoring a patient's condition, the method comprising:
presenting a plurality of forms to a caregiver by way of a mobile computing device, each one of the plurality of forms being related to the patient's physical condition and appearance;
receiving input from the caregiver by way of the plurality of forms;
transmitting data from the plurality of forms from the mobile computing device to a main computer by way of a data communications network; and
in the event the data indicates a condition, for the patient, that is outside normal parameters, receiving instructions from a monitoring computer.

20. The method of claim 19, wherein the plurality of forms also relates to the patient's medication.

21. The method of claim 19, further comprising initiating a two-way communication between the monitoring computer and the mobile computing device in the event that the caregiver requires clarification for instructions from the monitoring computer.

22. The method of claim 19, wherein the monitoring computer is operated by a registered medical professional.

23. The method of claim 19, wherein the plurality of forms relates to medication for the patient.
